(19) United States
(12) Patent Application Publication
(10) Pub. No.: US 2019/0111815 A1
(43) Pub. Date: Apr. 18, 2019

(54) Car Seat Catching System

(71) Applicant: Luis Adrian Diaz, Commerce City, CO (US)

(72) Inventor: Luis Adrian Diaz, Commerce City, CO (US)

(21) Appl. No.: 16/229,025

(22) Filed: Dec. 21, 2018

Related U.S. Application Data
(60) Provisional application No. 62/523,098, filed on Jun. 21, 2017.

(51) Int. Cl. B60N 2/60; A47D 1/00

(52) U.S. Cl. CPC B60N 2/6009; B60N 2/28; A47D 1/008; A47D 1/006

(57) ABSTRACT

A car seat catching system for spilled liquids and dropped objects. At least one collection sheet surrounds a child car seat. The collection sheet may have one or more rib to support the collection sheet and provide at least semi-rigid, bowl-shaped support for the at least one collection sheet. In an example with a base, a removable tray can be provided within the base. The base is configured to collect crumbs and smaller objects in the removable tray, while blocking larger objects from entering into the base so that the larger objects remain on the at least one collection sheet for retrieval by a child in the child car seat and/or other person.

### BACKGROUND

Children, particularly babies and toddlers, tend to make messes while riding in a car or other vehicle. For example, a child may drop a bottle or drink cup, causing the liquid to spill out onto the seat and onto the carpet. Food, toys, and other items may also fall out of the child's hand, and land randomly about the back seat of the vehicle. This is true of other child seating areas as well.

### BRIEF DESCRIPTION OF THE DRAWINGS

FIG. 1 is an isometric view of an example car seat catching system.

FIGS. 2A and 2B are cutaway views of an example base of the car seat catching system.

FIGS. 3A-D are isometric views of an example car seat catching system illustrating example installation in a vehicle.

FIG. 4 shows an example implementation of multiple car seat catching systems.

FIG. 5 shows an example accessory for the car seat catching system.

FIGS. 6A-B and 7-8 show another example car seat catching system.

FIG. 9 is a top view of another example car seat catching system.

FIG. 10 is a bottom view of the example car seat catching system shown in FIG. 9.

FIG. 11 is an isometric view of the example car seat catching system shown in FIG. 9.

FIGS. 12-14 are isometric views of the example car seat catching system shown in FIG. 9 as it may be provided with a child car seat.

FIG. 15 is an isometric view of the example car seat catching system shown in FIG. 9 as it may be folded for storage.

### DETAILED DESCRIPTION

A car seat catching system is disclosed. The car seat catching system reduces or altogether eliminates cleaning of messes made by a child during a car ride. Examples of the catching system may also be configured for use on planes, buses, trains, shopping carts, and/or other areas where a child may be seated. It can also keep toys and bottles within a reachable range for the child, or for a nearby parent (e.g., in the front seat) to easily grab a dropped bottle or toy to calm a fussy child.

In an example, the car seat catching system may be shaped substantially as an upside-down umbrella with hollow base having a tray to easily dispose of any trash that may accumulate over a period of time (e.g., during a car ride).

Before continuing, it is noted that as used herein, the terms “includes” and “including” mean, but is not limited to, “includes” or “including” and “includes at least” or “including at least.” The term “based on” means “based on” and “based at least in part on.”

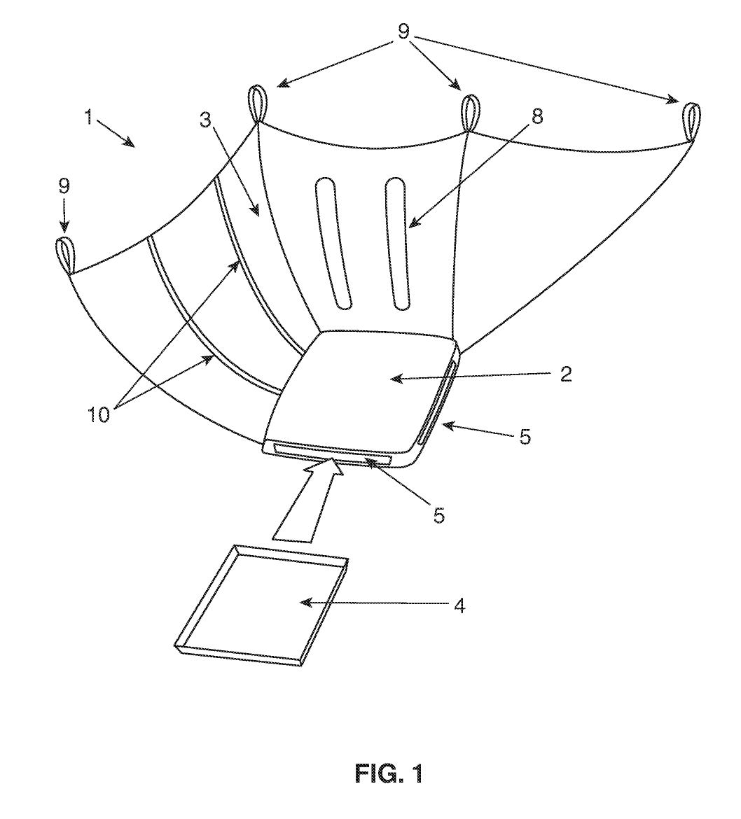

FIG. 1 is an isometric view of an example car seat catching system 1. In an example, a car seat catching system 1 includes a base 2 and a collection sheet 3. It is noted that a base is not required, but may be provided, such as in the example illustrated in FIG. 1. The base 2 is configured to be positioned under a child's seat (e.g., a car seat or booster seat) in an automobile or other location. The collection net or sheet 3 can be spread out or stretched around the base, and optionally hung (e.g., on a coat rack by the window in the car, on a seat back, an adjacent seat, etc.). In an example, the car seat catching system 1 may have a general appearance similar to an upside-down umbrella. The collection sheet 3 thus provides a catchment area, e.g., for drinks that may spill and/or other items that may fall loose when dropped by the child.

An optional upper net (not shown) may also be provided. In an example, this upper net can attach at the top edge of the collection sheet 3 (e.g., by Velcro®) and be connected to the coat hanger, upper grab handles, or attachment points in the vehicle (e.g., by suction cups to the windows, or by hook-and-loop attachment the ceiling). The net may have one or more openings (e.g., in the front and/or sides) in order for a parent to be able to grab toys or bottles.

In an example, the collection sheet 3 may be configured with at least one opening 8 to secure to a seat, e.g., via a seat belt. The collection sheet 3 may also include one or more strap 9 which may be attached to any suitable attachment point in the vehicle (e.g., to a seat back, coat hook, etc.). Straps 9 may include loops and/or any suitable fasteners (e.g., a hook-and-loop or VELCRO®, snaps, etc.) for attachment to the attachment point in the vehicle. In an example, at least one rib 10 to provide structure for the sheet (e.g., metal or plastic or other rigid or semi-rigid structure).

Although a two-sided collection sheet 3 is shown in FIG. 1, it is understood that the collection sheet 3 may have any number of sides. Additional collection nets or sheets may also be provided.

In an example, the base 2 includes a removable internal storage tray 4. The tray may be positioned in opening 5 of the base 2. In an example, the tray 4 may be provided to store the collection sheet 3 and/or attachments and/or other items.

In an example, the tray 4 may allow for the collection and easy removal of crumbs. In an example configuration, the base 2 is a hollow square base about three inches or less in height that may be placed underneath the car seat. The base may have one or more openings 5 (and other openings on the opposite sides, not visible in FIG. 1). The openings 5 may be small enough to prevent toys or bottles from entering the tray, but to permit small particles of food and/or trash to collect in the tray 4 for quick and easy disposal. Toys and bottles will remain on the sheets, adjacent to the base 2 so that they can be readily reached by the child and/or parent.

The bottom of the base 2 may have hook and loop attachments or Velcro® attached around the perimeter to enable the collection sheet 3 to attach thereto, creating both a seal and a path toward the a collection tray 4.

Before continuing, it should be noted that the examples described above are provided for purposes of illustration, and are not intended to be limiting. Other devices and/or device configurations may be utilized to carry out the operations described herein.

In addition, the operations shown and described herein are provided to illustrate example implementations. It is noted that the operations are not limited to the ordering shown. Still other operations may also be implemented.

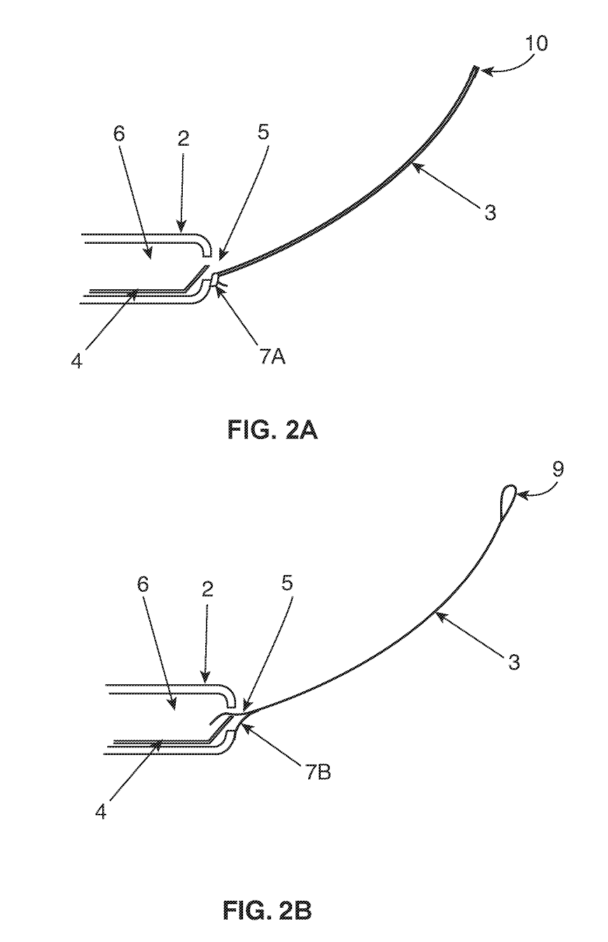

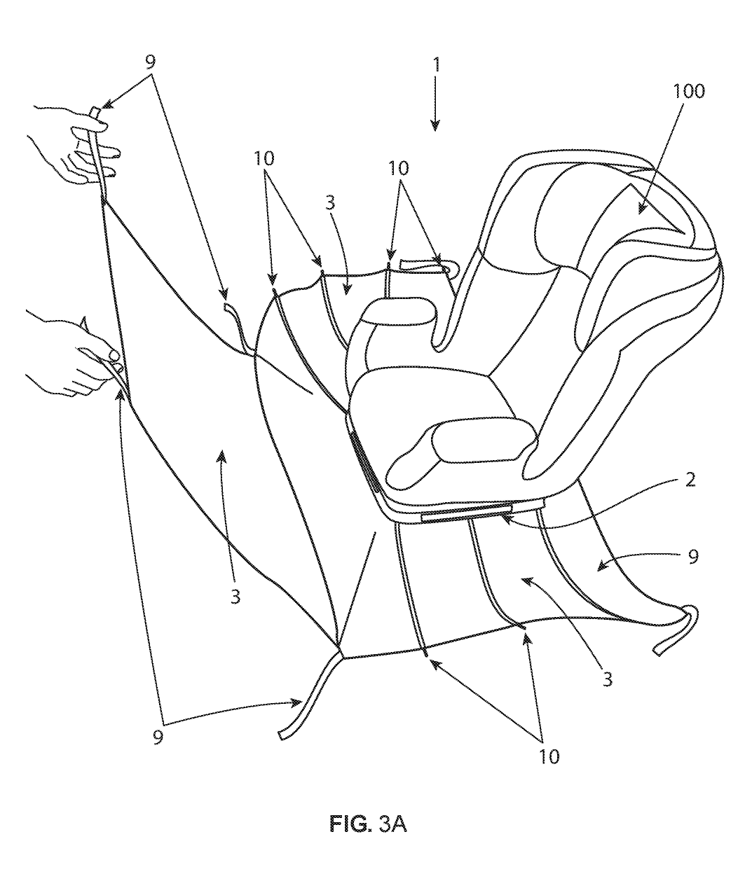

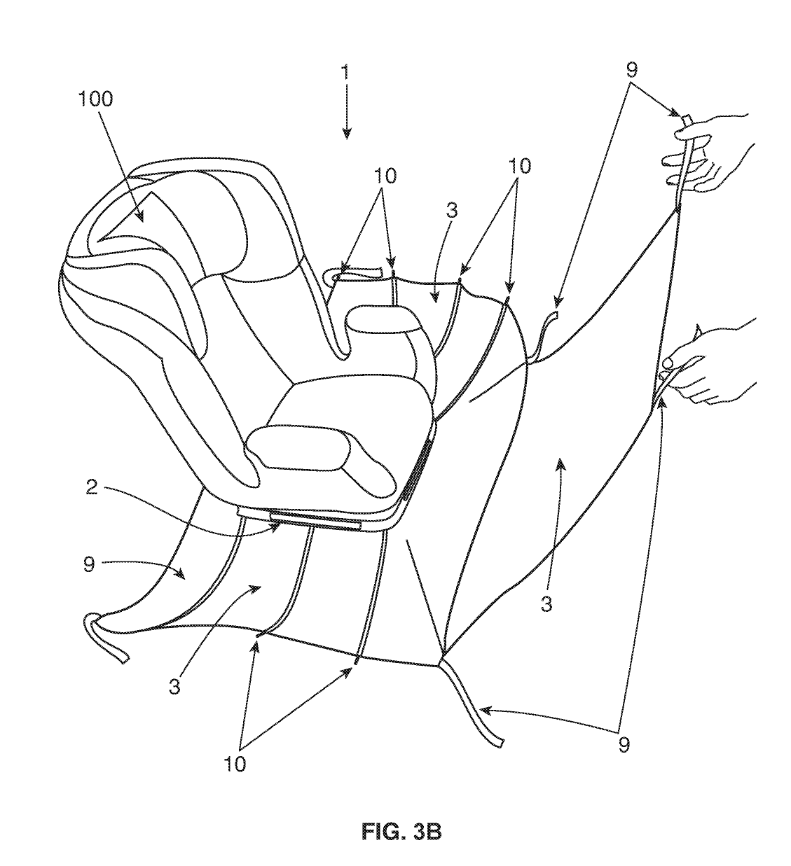

FIGS. 2A and 2B are cutaway views of an example base of the car seat catching system. In an example, the base includes a hinge placement 7A (in FIG. 2A) or 7B (in FIG. 2B) just below a slot or opening 5 to attach the collection sheet 3 adjacent the chamber 6 within the base 2. The hinge placements 7A and 7B may be provided as an anchor to connect the collection sheet 3. The hinge placements 7A and 7B may also enable connection of one or more wires or metal ribs 10 to support the collection sheet 3 (e.g., in a manner similar to an umbrella).

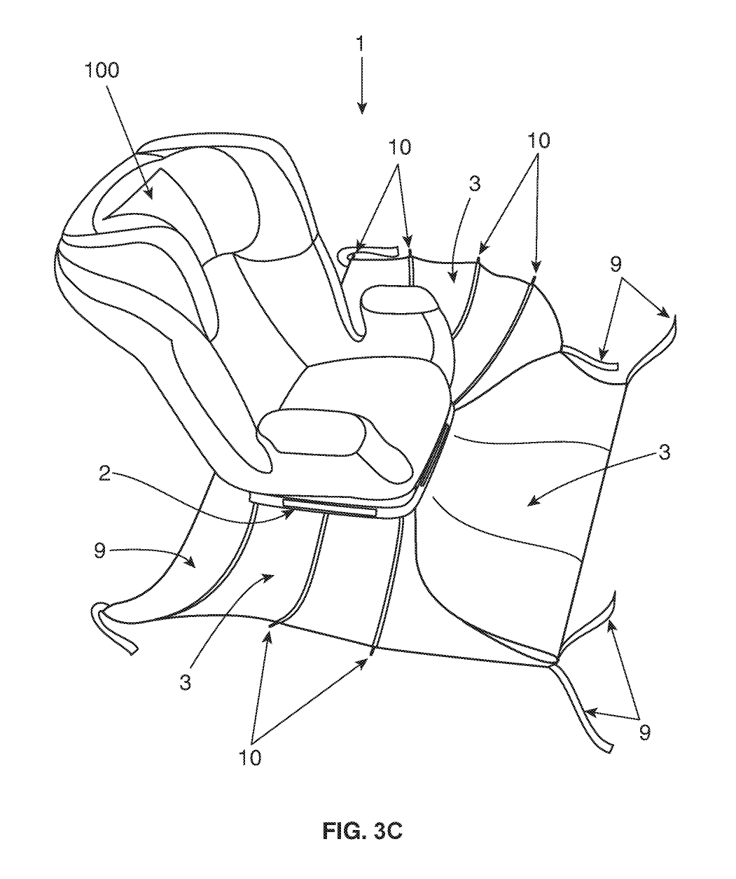

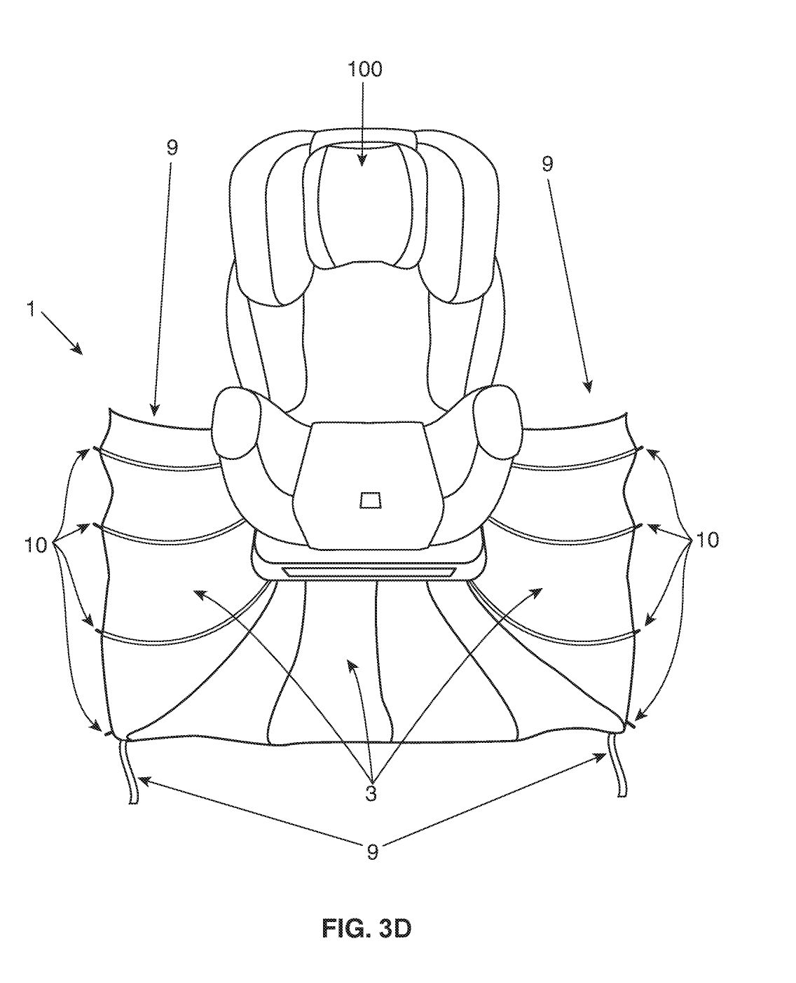

FIGS. 3A-D are isometric views of an example car seat catching system 1 illustrating example installation in a vehicle. FIG. 3A is a left-side perspective view of the car seat catching system 1 as it may be installed by setting the base 2 on the seat of the vehicle and unfolding the collection sheet(s) 3. FIG. 3B is a right-side perspective view of the car seat catching system 1 as shown in FIG. 3A. FIG. 3C corresponds to the view in FIG. 3B, and shows the collection sheets 3 in an expanded form prior to hanging on various attachment points. It is noted that the car seat catching system 1 can be used in this configuration (e.g., without hanging on attachment points). For example, the structures 10 may serve to hold the collection sheets in a substantially upside-down umbrella configuration without further attachment. Alternatively, one or more of the collection sheets 3 may be attached to one or more attachment points in the vehicle (e.g., to the heatrest, to the windows, coat hooks, etc.).

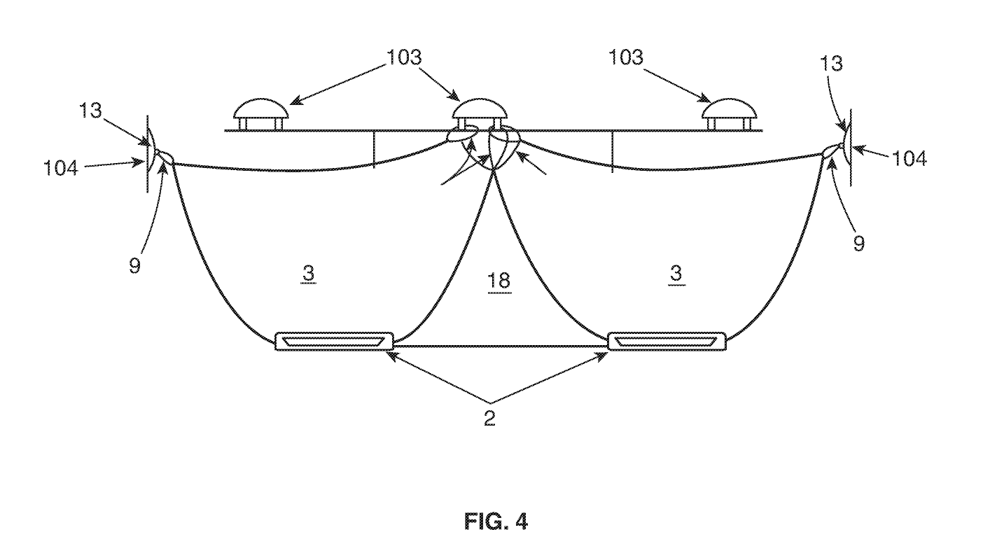

FIG. 4 shows an example configuration implementing multiple car seat catching systems 1 together in a vehicle, e.g., for more than one child or to cover a larger seating area. In this example, a plurality of bases 2 and sheets 3 are provided for seating multiple children and/or covering multiple seats. The collection sheets 3 may be attached at any suitable attachment points (e.g., headrests 103 on the seats and suction cups 13 on windows 104). Also in this example, a connector sheet 18 is provided that fills the space between sheets 3 of multiple car seat catchers 1.

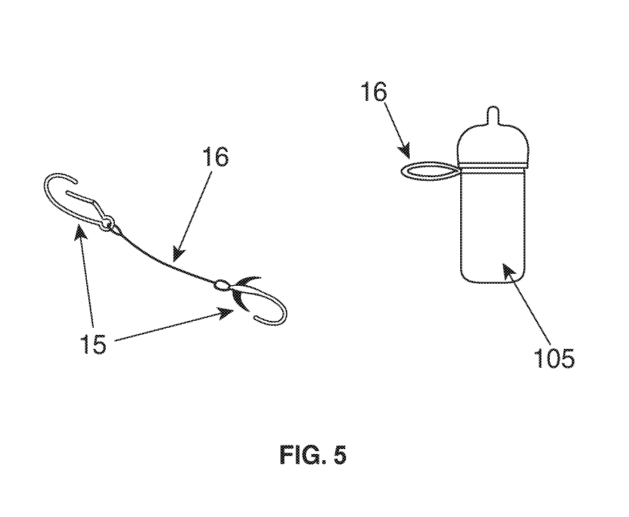

FIG. 5 shows an example accessory catcher 16 for the car seat catching system 1. The accessory catcher 16 can be attached to any bottle or toy 105 and hang from the collection sheet 3, or elsewhere on the car seat catching system 1 or elsewhere (e.g., a headrest on the front seat, or other suitable location) to arrest the fall of the object and keep the bottle or toy 105 within reach for easy retrieval by the child or parent.

In an example, the accessory catcher 16 may include a clasp 15 on each end of a cable so that it may hang from a uitable attachment point on one end, and clip to an object, toy, or bottle 105 on the other end. As a design choice, the cable 16 may be either elastic or inelastic.

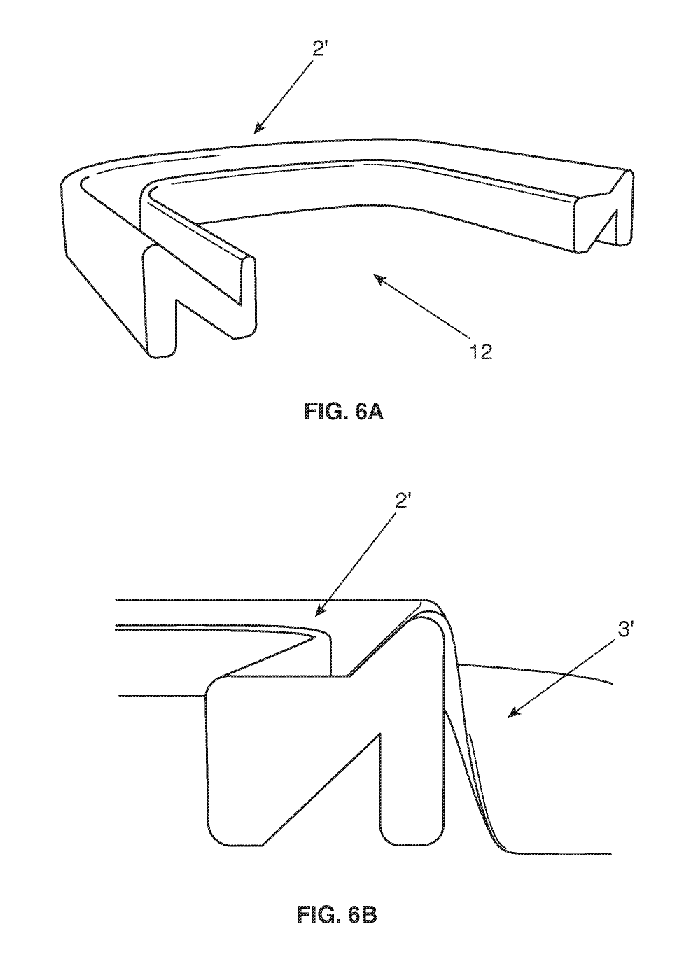

FIGS. 6A-B and 7-8 show another example car seat catching system. In this example, the base 2′ is substantially U-shaped, as indicated by reference 12 in FIG. 6A. In FIGS. 6B and 7, the collection sheet 3′ is shown as it may be attached to the base 2′. When a child car seat is placed on top of the base, a void forms a slot 14 beneath the child car seat through which an internal collection tray 4 (see, e.g., FIG. 1) may be slid into or or out of the base 2′.

FIG. 8 is a cross-sectional view of an example base 2′ of a car seat catching system 1. As a design choice, the base may be made in any of a wide variety of cross-sectional forms that serve the intended purpose,

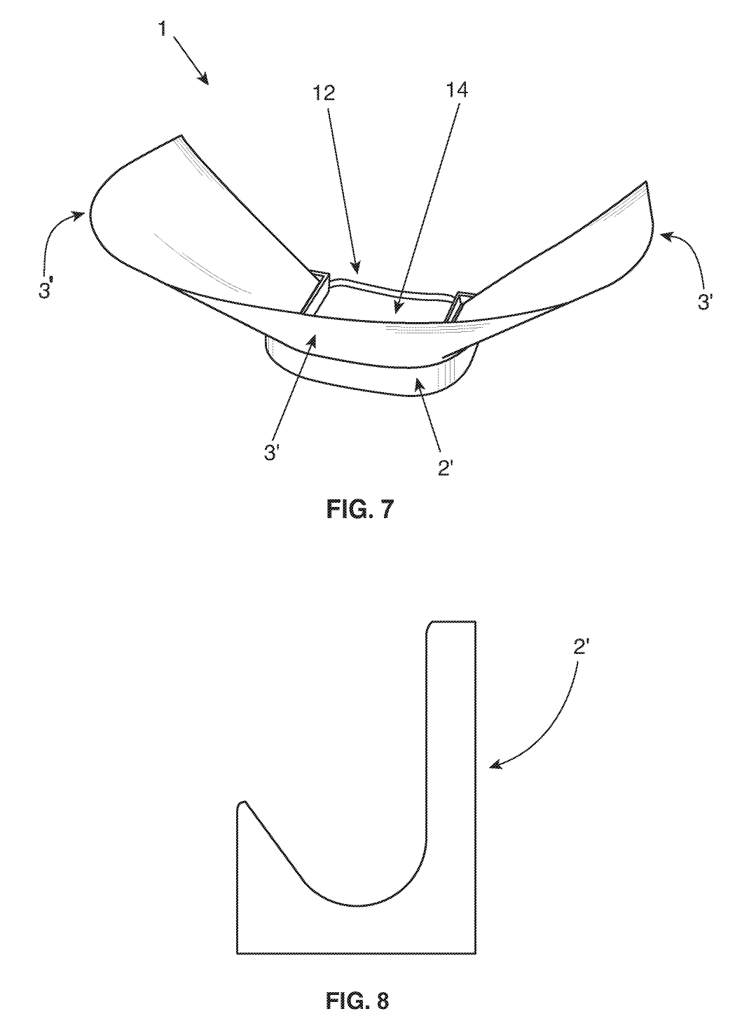

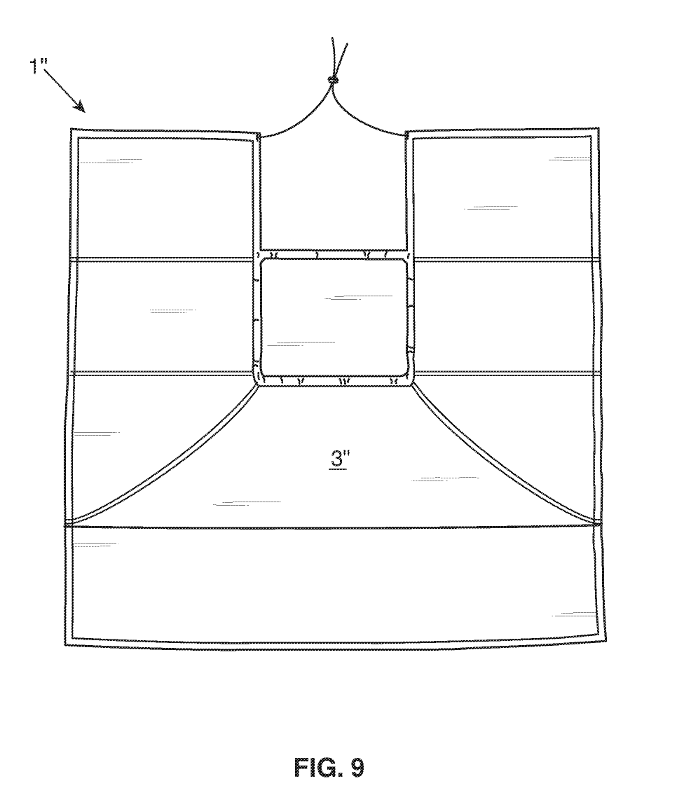

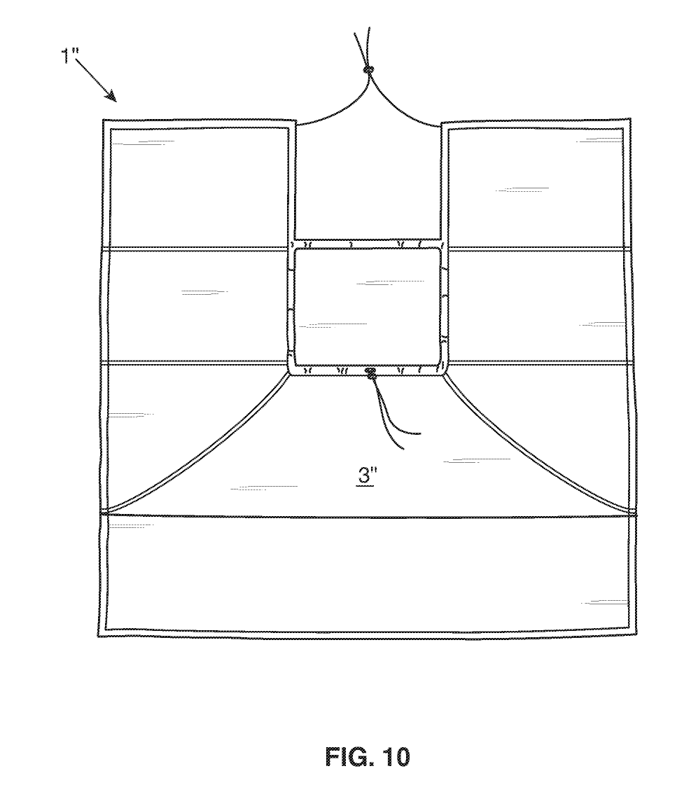

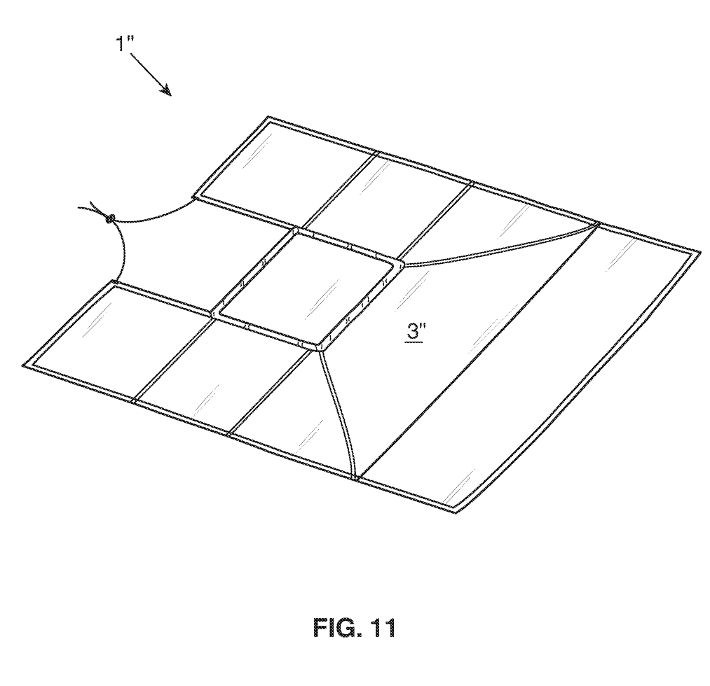

FIG. 9 is a top view of another example car seat catching system 1″. FIG. 10 is a bottom view of the example car seat catching system 1″ shown in FIG. 9. FIG. 11 is an isometric view of the example car seat catching system 1″ shown in FIG. 9. In this example, the car seat catching system does not include a base (i.e., it is “baseless”).

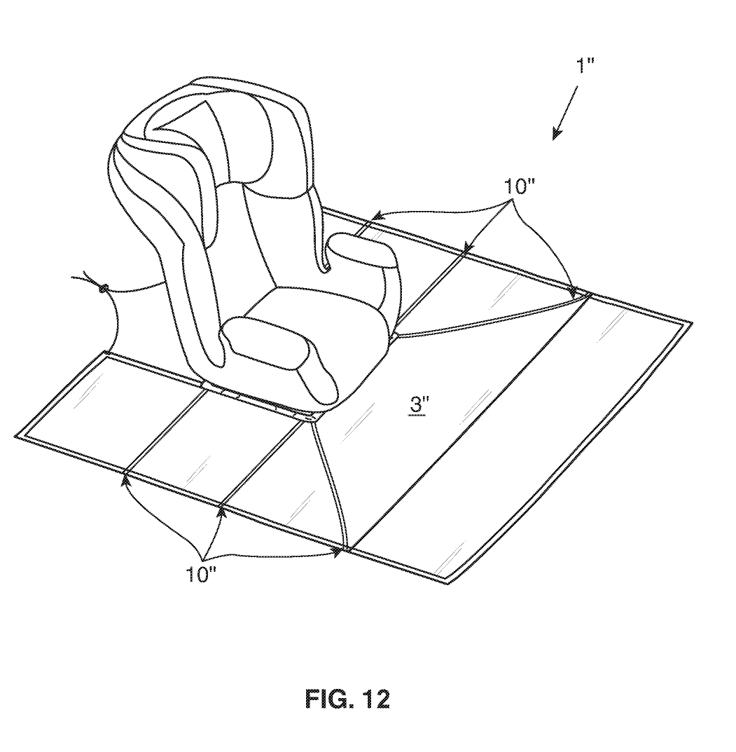

The example car seat catching system 1″ may include a collection sheet 3″ for surrounding and attaching to a car seat 100. FIGS. 12-14 are isometric views of the example car seat catching system shown in FIG. 9 as it may be provided with a child car seat 100″.

In an example, the collection sheet 3″ has a portion substantially in the center for positioning under the car seat 100″. Also in an example, the collection sheet 3″ is a substantially U-shaped configuration. A hem may be provided around one or more edge, such as around all or part of the the perimeter of the collection sheet 3″ for retaining one or more drawstring. The drawstring may be pulled to tighten the portion under the car seat around the base of the car seat 100″.

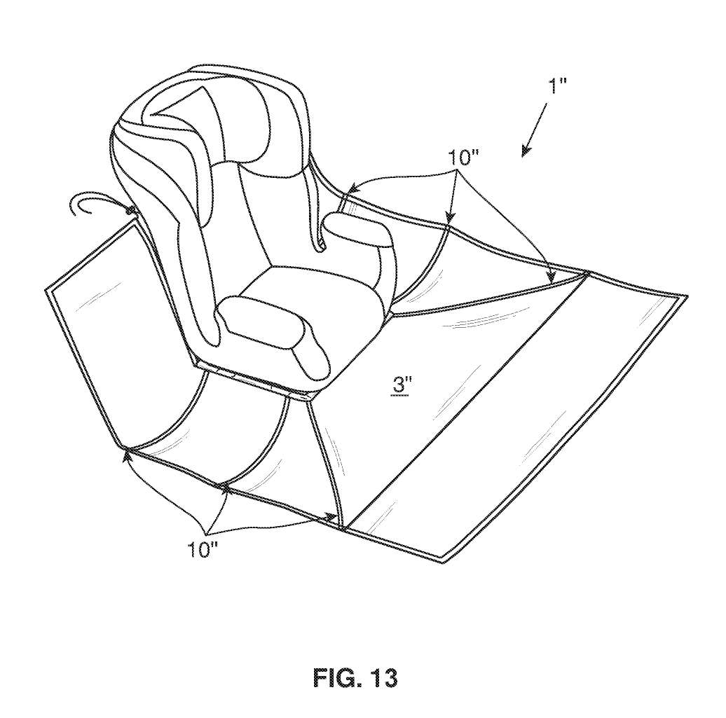

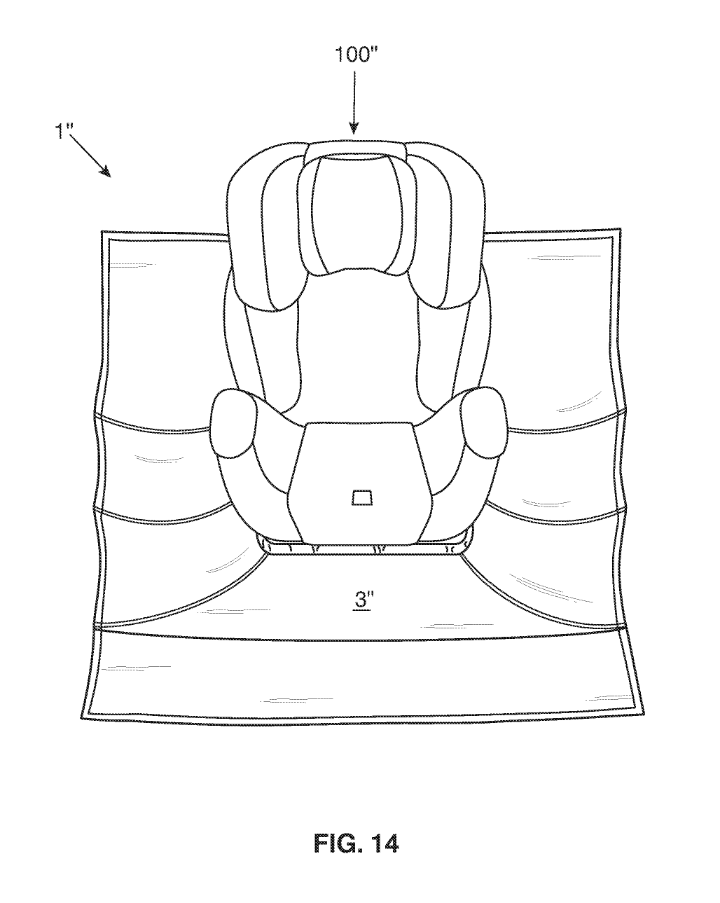

A plurality of ribs 10″ may be provided in (e.g., sewn into) the collection sheet 3″. The ribs 10″ support the collection sheet 3″ outward from the car seat 100″ and form a semi-rigid bowl-shaped support out of the collection sheet 3″ from around the base of the child car seat 100″. In an example, the ribs 10″ change from a substantially straight rod configuration (e.g., as shown in FIG. 12) and bend into a curved or bow-shape configuration (e.g., as shown in FIGS. 13 and 14) when the draw string is tightened about the base of the child car seat 100″. This bowl shape provides a catch basin for a child's toys, food and drink containers, trash, and other objects that may fall around the car seat 100″.

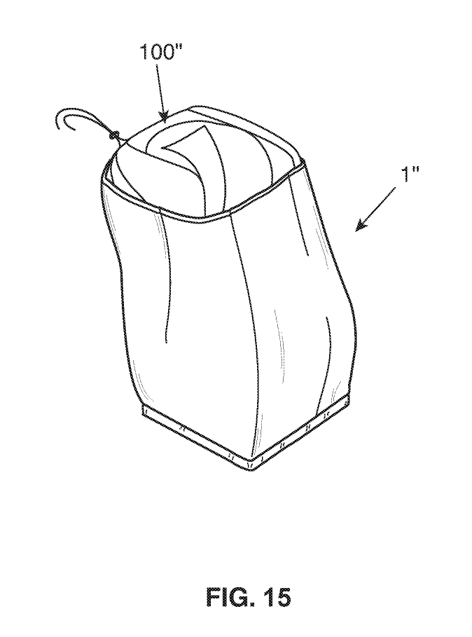

FIG. 15 is an isometric view of the example car seat catching system 1″ shown in FIG. 9 as it may be folded around the car seat 100″, e.g., for storage or transporting both the car seat 100″ and system 1″. In the example illustrated in the drawing, the sides of the collection sheet 3″ are raised up around the car seat 100″, and the drawstring may be pulled tight to close or cinch the top shut. As such, the collection sheet 3″ wraps around the child car seat 100″ to enclose the child car seat 100″ as in a carrying bag configured for the child car seat.

Other examples of the car seat catching system are also contemplated as being within the scope of the disclosure herein, as will be readily appreciated by those having ordinary skill in the art after becoming familiar with the teachings herein. For example, the collection sheets may be made of fully waterproof materials. The hook-and-loop attachments on the base may be replaced with water-tight attachments, thus forming a water-tight seal between the sheet and the base and allowing liquids to be channeled more effectively into the collection tray. The components may be made from a variety of materials including but not limited to metals, plastics, polymers, foamed polymers, and wood. The sheets, flaps, straps, hook and loop placements, and cable may be made from a variety of materials including, but not limited to, plastics, polymers, and textiles. The sheets may be suspended by suction cups, loops, stretchers (similar to an umbrella), or by any combination thereof. The collection sheets may be connected to the base by any suitable means, including but not limited to, removable attachments (e.g., snaps, hook-and-loop, etc.) and/or non-removable attachments (e.g., with a glued or welded seam, etc.).

It is noted that the examples shown and described are provided for purposes of illustration and are not intended to be limiting. Still other examples are also contemplated.

1. A car seat catching system for spilled liquids and dropped objects, comprising:
a base configured to be positioned under a child car seat, the base having a top, a bottom, and at least four sides, wherein an opening is formed in at least one of the four sides; and
at least one collection sheet surrounding and attached to at least one of the four sides of the base.

2. The car seat catching system of claim 1, further comprising a removable internal collection tray within the base.

3. The car seat catching system of claim 2, wherein the opening is sized in the base for insertion and removal of the internal collection tray.

4. The car seat catching system of claim 3, wherein liquids and small objects pass through the opening formed in at least one of the four sides and into the collection tray, but larger objects do not pass through the opening and thus remain on the at least one collection sheet.

5. The car seat catching system of claim 1, further comprising at least one rib in the at least one collection sheet.

6. The car seat catching system of claim 5, wherein the at least one rib provides at least semi-rigid support for the at least one collection sheet.

7. The car seat catching system of claim 5, wherein the at least one rib provides bowl-shaped support for the at least one collection sheet.

8. The car seat catching system of claim 5, wherein the at least one rib supports the at least one collection sheet outward from the base.

9. The car seat catching system of claim 1, further comprising an attachment on the at least one collection sheet for connecting the at least one collection sheet to an attachment point in a vehicle.

10. The car seat catching system of claim 9, wherein the attachment is a suction cup affixed to a window or other flat surface of the vehicle.

11. The car seat catching system of claim 1, further comprising an accessory catcher having:
a cable;
a first end of the cable for attaching adjacent the base;
a second end of the cable for attaching to an object.

12. The car seat catching system of claim 1, further comprising a plurality of bases, and corresponding collection sheets for seating multiple children and/or covering multiple seats.

13. The car seat catching system of claim 12, further comprising a connection sheet for interconnecting the corresponding collection sheets.

14. The car seat catching system of claim 1, further comprising a net to catch and contain thrown objects.

15. The car seat catching system of claim 1, wherein the base is substantially U-shaped and the child car seat sits on raised edges of the base to form a void within the U-shape.

16. The car seat catching system of claim 15, wherein the base has a slot formed on each of the legs of the U-shape, the slots for receiving crumbs and smaller objects while blocking larger objects from entering the void formed within the U-shape.

17. The car seat catching system of claim 15, further comprising a removable tray insertable into the void formed within the U-shape to collect crumbs and smaller objects therein, while larger objects remain on the at least one collection sheet for retrieval by a child in the child car seat and/or other person.

18. A car seat catching system for spilled liquids and dropped objects, comprising at least one collection sheet for surrounding and attaching to a car seat, the at least one collection sheet having a portion for positioning under the car seat, the portion being substantially in a center of the collection sheet, and the at least one collection sheet having a substantially U-shaped configuration with a hem for retaining a drawstring.

19. A car seat catching system for spilled liquids and dropped objects, comprising:
at least one collection sheet for surrounding a child car seat;
a draw string to tighten about a base of the child car seat; and
a plurality of ribs in the at least one collection sheet, the plurality of ribs supporting the at least one collection sheet outward from the car seat and forming a semi-rigid bowl-shaped support from the at least one collection sheet around the base of the child car seat, wherein the plurality of ribs change from a substantially straight rod configuration into a curved bow configuration when the draw string is tightened about the base of the child car seat;
wherein the at least one collection sheet wraps around the child car seat to enclose the child car seat as in a carrying bag for the child car seat.

20. The car seat catching system of claim 19, further comprising:
a base configured to be positioned under the child car seat, the base having a top, a bottom, and at least four sides, wherein an opening is formed in at least one of the four sides; and
a removable tray provided within the base, the base has a slot formed on at least one of the four sides, the slots configured to collect crumbs and smaller objects in the removable tray, while blocking larger objects from entering into the base so that the larger objects remain on the at least one collection sheet for retrieval by a child in the child car seat and/or other person.
